(19) United States
(12) Patent Application Publication
(10) Pub. No.: US 2026/0264231 A1
(43) Pub. Date: Sep. 10, 2026

(54) CONTROL MODEL GENERATION DEVICE, ROBOT CONTROL DEVICE, AND CONTROL SYSTEM

(71) Applicant: MITSUBISHI ELECTRIC CORPORATION, Tokyo (JP)

(72) Inventors: Toshiaki KUBO, Tokyo (JP); Seiji KOZAKI, Tokyo (JP); Fumiki HASEGAWA, Tokyo (JP); Takeshi IMAI, Tokyo (JP)

(73) Assignee: MITSUBISHI ELECTRIC CORPORATION, Tokyo (JP)

(21) Appl. No.: 19/165,593

(22) PCT Filed: Mar. 27, 2023
(86) PCT No.: PCT/JP2023/012335

§ 371 Date: Sep. 16, 2025

(51) Int. Cl. B25J 9/16

(52) U.S. Cl. CPC B25J 9/163; B25J 9/1671

(57) ABSTRACT

A control model generation unit according to the present disclosure includes: a data storage unit that stores personal action data that is data related to an activity of a person who has performed a cooperative activity; and a learning unit that generates, by using the personal action data stored in the data storage unit, a control model of a humanoid for the humanoid to perform the cooperative activity with a user, the control model reflecting a personality of the person. The personal action data includes data acquired when the user performs the cooperative activity with a cooperative activity target person with which the user is familiar.

### FIELD

The present disclosure relates to a control model generation device, a robot control device, a control system, a control model generation method, and a program.

### BACKGROUND

In recent years, devices capable of interacting with a person, such as service robots and smart speakers, have been developed. In addition, interaction between a virtual character and a user is also possible in a virtual space on a computer such as metaverse. Devices or virtual characters capable of human interaction are examples of humanoids. A humanoid is required to perform an action and speech and conduct suitable for an individual so as not to give stress while living together with the individual. However, in general, the same device (or virtual character) has the same action and way of speaking regardless of the user, that is, the interaction partner, and the same device (or virtual character) can make some users feel stress.

Patent Literature 1 discloses a robot control device that controls an action of a robot so that an expected reaction by the action of the robot matches an actual reaction of the user to the action in order to enable the robot to construct an affinity relationship with the user.

### CITATION LIST

### Patent Literature

Patent Literature 1: Japanese Patent Application Laid-open No. 2013-027937

### SUMMARY OF INVENTION

### Problem to be Solved by the Invention

However, in the technique described in Patent Literature 1, in a case where the expected reaction by the action of the robot does not match the actual reaction of the user to the action, the action of the robot is controlled such that the expected reaction matches the actual reaction of the user. That is, after the robot performs an actual activity that is inappropriate, the subsequent action of the robot is controlled. For this reason, an inappropriate activity is performed, and the user feels stress to some extent. Furthermore, the user may wish to reflect a personality that is the action and/or the way of speaking of a specific person in the humanoid.

The present disclosure has been made in view of the above, and an object thereof is to obtain a control model generation device capable of reducing the user's stress due to the action and/or the way of speaking of the humanoid.

### Means to Solve the Problem

In order to solve the above-described problems and achieve the object, a control model generation device according to the present disclosure comprises: a data storage unit to store personal action data that is data related to an activity of a person who has performed a cooperative activity; and a learning unit to generate, by using the personal action data stored in the data storage unit, a control model of a humanoid for the humanoid to perform the cooperative activity with a user, the control model reflecting a personality of the person. The personal action data includes data acquired when the user performs the cooperative activity with a cooperative activity target person with which the user is familiar.

### Effects of the Invention

The control model generation device according to the present disclosure can achieve the effect of reducing the user's stress due to the action and/or the way of speaking of the humanoid.

### BRIEF DESCRIPTION OF DRAWINGS

FIG. 1 is a diagram illustrating an exemplary configuration of a cooperative activity system according to the first embodiment.

FIG. 2 is a diagram illustrating an example of correction information according to the first embodiment.

FIG. 3 is a schematic diagram illustrating an example of a neural network.

FIG. 4 is a flowchart illustrating an exemplary procedure in the control model generation unit according to the first embodiment.

FIG. 5 is a flowchart illustrating an exemplary procedure in the robot control unit according to the first embodiment.

FIG. 6 is a schematic diagram illustrating an example of acquisition of personal action data in the first example.

FIG. 7 is a schematic diagram illustrating an example of a cooperative activity between the user and the robot in the first example.

FIG. 8 is a schematic diagram illustrating an example of acquisition of personal action data in the second example.

FIG. 9 is a schematic diagram illustrating an example of a cooperative activity between the user and the robot in the second example.

FIG. 10 is a diagram illustrating an exemplary configuration of a computer system that implements the control system according to the first embodiment.

FIG. 11 is a diagram illustrating an exemplary configuration of a cooperative activity system according to the second embodiment.

FIG. 12 is a flowchart illustrating an exemplary procedure in the control model generation unit according to the second embodiment.

FIG. 13 is a diagram illustrating an exemplary configuration of a cooperative activity system according to the third embodiment.

FIG. 14 is a flowchart illustrating an exemplary procedure of control model update processing in the control model generation unit according to the third embodiment.

FIG. 15 is a diagram illustrating an exemplary configuration of a cooperative activity system according to the fourth embodiment.

FIG. 16 is a diagram illustrating an exemplary configuration of a cooperative activity system according to the fifth embodiment.

FIG. 17 is a diagram illustrating an exemplary configuration of a cooperative activity system according to the sixth embodiment.

### DESCRIPTION OF EMBODIMENTS

Hereinafter, a control model generation device, a robot control device, a control system, a control model generation method, and a program according to embodiments will be described in detail with reference to the drawings.

### First Embodiment

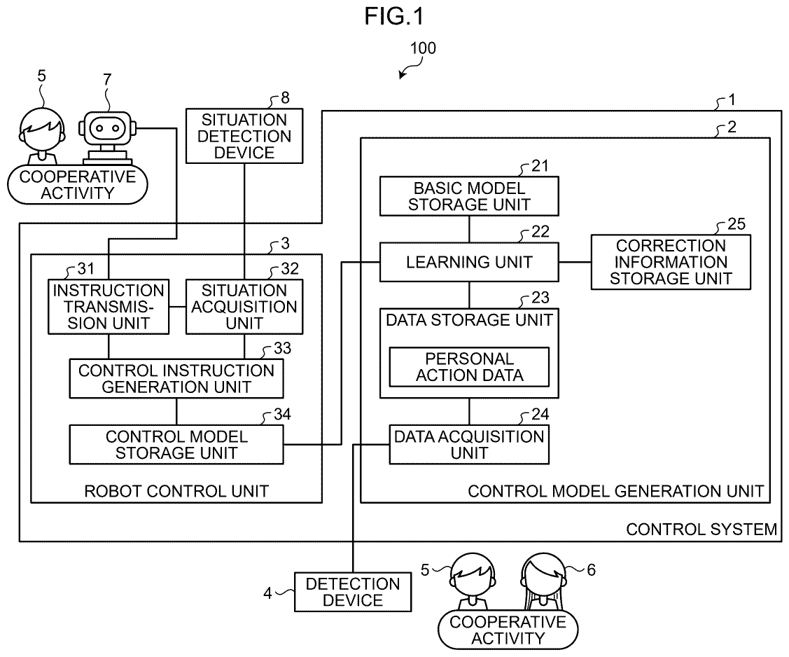

FIG. 1 is a diagram illustrating an exemplary configuration of a cooperative activity system according to the first embodiment. The cooperative activity system 100 of the present embodiment includes a control system 1, a robot 7, a detection device 4, and a situation detection device 8.

Before the cooperative activity between the robot 7 and a user 5 is performed, the cooperative activity system 100 of the present embodiment accumulates personal action data of the user 5 including cooperative activity data acquired when the cooperative activity is performed with a cooperative activity target person 6, and generates a control model for controlling the robot 7 using the accumulated personal action data. The cooperative activity data is personal action data acquired when the cooperative activity is performed. The acquired personal action data may be only cooperative activity data or may include data other than the cooperative activity data.

The cooperative activity includes, for example, but is not limited to, at least one of a conversation, a work, a game, or a sport. The cooperative activity target person 6 is another person who performs the cooperative activity with the user 5, and is familiar with the user 5 in the cooperative activity. A person who is familiar with the user 5 in the cooperative activity is, for example, a person who has met the user 5 before and knows each other's personality or habit of speech and conduct to some extent, and therefore, a person to whom the user 5 feels congenial in the cooperative activity, and is less likely to feel stress when the user 5 performs the cooperative activity together. For example, the cooperative activity target person 6 may be determined by the user 5, or may be determined by an operator of the cooperative activity system 100 different from the user 5. In a case where the cooperative activity target person 6 is determined by the operator of the cooperative activity system 100 or the like, for example, a person who is clearly known to have performed a cooperative activity with the user 5 for a long period of time is determined as the cooperative activity target person 6. The number of cooperative activity target persons 6 may be one or more. In a case where there are a plurality of cooperative activity target persons 6, personal action data including cooperative activity data at the time when the user 5 performs the cooperative activity with each of the cooperative activity target persons 6 is acquired. For example, in a case where the cooperative activity target person 6 includes a first cooperative activity target person and a second cooperative activity target person, the personal action data of the user 5 includes cooperative activity data acquired at the time of the cooperative activity between the first cooperative activity target person and the user 5 and cooperative activity data acquired at the time of the cooperative activity between the second cooperative activity target person and the user 5.

The personal action data is data related to the action of a person who has performed the cooperative activity, and in the present embodiment, since the personal action data of the user 5 is acquired, the personal action data is data reflecting the personality of the user 5. Since the personal action data of the user 5 includes data acquired when the user 5 is performing the cooperative activity with the cooperative activity target person 6 with which the user 5 is familiar, it can be said that the personal action data is data in which the personality of the cooperative activity target person 6 is indirectly reflected. Furthermore, since the control model is generated using the personal data including the data of the user 5 acquired when the user 5 is performing the cooperative activity with the cooperative activity target person 6 familiar with the user 5, the personality of the user 5 is reflected in the control model. Here, since the personality of the user 5 reflected in the control model is not merely the personality of the user 5 but the personality of the user 5 performing the cooperative activity with the cooperative activity target person 6 familiar with the user 5, not only the personality of the user 5 but also the personality of the cooperative activity target person 6 familiar with the user 5 is indirectly reflected in the control model. The control with indirect reflection is control in which the action or the way of speaking of the cooperative activity target person 6 involved with the user 5 is reflected, and can also be said to be control including an element that is a characteristic action or way of speaking forming the personality of the cooperative activity target person 6. As a result, the robot 7 can perform such an action that the user 5 does not feel stress when performing the cooperative activity.

In addition, the personal action data is data including the habit of activity of the user 5. Here, the action is assumed to be a target used for controlling the robot 7, and may include not only the motion but also the way of speaking of the user 5 and/or the position and posture of the user 5. That is, the action includes, for example, the way of movement and the way of speaking and/or the position and/or posture of the user 5. The way of movement may include not only one that indicates continuous movement but also the position and/or posture at a certain moment. The habit of activity includes the habit of movement and/or the habit of speaking. The habit of movement is, for example, at least one of the way of movement such as moving trajectory and moving speed, gestures, or the like, and the habit of speaking is, for example, at least one of the speed of speaking, habitual saying, ways of speaking, intonation, dialect, or the like, but is not limited thereto. Note that the activities, actions, ways of speaking, habits, and the like of the user 5, the cooperative activity target person 6, and the robot 7 may be referred to as behavior.

The robot 7 is an example of a humanoid that performs a cooperative activity with the user 5. Note that a humanoid may be referred to as a control target. More specifically, in the present embodiment, the robot 7 is an example of a machine that performs cooperative activity with the user 5. The robot 7 may be a humanoid, may be a machine that does not include a movable portion and performs only communication with the user 5, may be an industrial machine that includes a manipulator or the like, or may be other machines, and there are no particular limitations on the shape and function.

The control system 1 controls the robot 7. The control system 1 includes a control model generation unit 2 that generates a control model of the robot 7, and a robot control unit 3 that controls the robot 7 using the control model generated by the control model generation unit 2 and situation data detected by the situation detection device 8. The control model generation unit 2 as a control model generation device and the robot control unit 3 as a robot control device may be integrated, or may be individually provided.

The detection device 4 detects, as personal action data, an action of the user 5 at the time when the user 5 is performing the cooperative activity together with the cooperative activity target person 6, and transmits the personal action data to the control model generation unit 2. The detection device 4 is, for example, a device that detects at least one of a position, a speed, an acceleration, a posture, a voice, a pulse, a blood pressure, a body temperature, an emotion, or the like, and there may be a plurality of detection devices 4.

Furthermore, the detection device 4 may detect biological information or psychological or internal information such as emotion of the user 5 at the time when the user 5 is performing the cooperative activity with the cooperative activity target person 6, include the detected information in the personal action data, and transmit the personal action data to the control model generation unit 2.

The detection device 4 may be a wearable terminal that can be worn by the user 5 or a portable terminal that can be carried by the user 5. In addition, the detection device 4 may be a device installed so as to be able to detect the activity of the user 5, or may be a device that detects an activity in a virtual space such as a metaverse. The detection device 4 may be a combination of these or may be other than these. In a case where the detection device 4 is a wearable terminal or a portable terminal, the detection device 4 may be a terminal capable of detecting at least one of the position, speed, or acceleration thereof, may be a terminal capable of detecting the rotation thereof, may be a terminal including a microphone or the like capable of collecting and recording a voice, or may be a combination thereof. For detection of the position of the wearable terminal, a global positioning system (GPS) receiver may be used, a radio frequency identification (RFID) tag may be used, or other devices may be used. By using a wearable terminal or a portable terminal as the detection device 4, not only the position of the user 5 but also personal action data of the user 5 can be acquired on a daily basis. When a voice is recorded, a sound made by a person other than the user 5 may be recorded, but the detection device 4, the control model generation unit 2, or a device that is not illustrated in FIG. 1 extracts the voice of the user 5 by performing voice recognition processing. The voice recognition processing may be any processing, for example, processing of acquiring the voice of the user 5 in advance and identifying the voice uttered by the user 5 using the voice acquired in advance.

In a case where a device installed so as to be able to detect the activity of the user 5 is used as the detection device 4, for example, the device may be an imaging device such as a camera that captures an image of a place where the cooperative activity is performed, may be a device such as a microphone capable of collecting sound and recording at the place where the cooperative activity is performed, or may be a combination thereof. In a case where the detection device 4 is an imaging device, the control model generation unit 2 or a device that is not illustrated in FIG. 1 recognizes the user 5 in the video captured by the imaging device, and detects the position, speed, acceleration, movement trajectory, and the like of the user 5. As a method of recognizing the user 5, a general image recognition method such as using an image of the user 5 captured in advance can be used. In addition, the detection device 4 may recognize the user 5 and detect the position, speed, acceleration, movement trajectory, and the like of the user 5. A general method can also be used as a method of detecting the position, speed, acceleration, movement trajectory, and the like of the user 5.

In a case where the detection device 4 is a device that detects an activity in a virtual space such as metaverse, the device may be, for example, a computer system that manages the virtual space, a terminal device used by the user 5 to operate a virtual self of the user 5 in the virtual space, or a device that records a video in the virtual space. In a case where a device that records a video in a virtual space is used as the detection device 4, the control model generation unit 2 or a device that is not illustrated in FIG. 1 recognizes the user 5 in the video captured by the imaging device, and detects the position, speed, acceleration, movement trajectory, and the like of the user 5.

Furthermore, in a case where the cooperative activity includes an activity using an object such as moving or processing some object, a device that detects a force or the like applied to the object by the user 5 may be included as the detection device 4.

The control model generation unit 2 includes a basic model storage unit 21, a learning unit 22, a data storage unit 23, a data acquisition unit 24, and a correction information storage unit 25. The basic model storage unit 21 stores a predetermined basic control model serving as a reference of a control model for controlling the robot 7. The basic control model is a general control model that does not depend on the user 5, that is, does not reflect the personality of the user 5, and is a model that defines the basic activity of the robot 7.

The basic control model may be stored in the data storage unit 23 in advance by a vendor of the control system 1, a vendor of the robot 7, or the like, or may be transmitted from another device, received by a communication unit (not illustrated in FIG. 1), and stored in the data storage unit 23. For example, by the user 5 operating the control system 1, the control system 1 may receive the basic control model from an external server or the like that provides the basic control model corresponding to the robot 7. Furthermore, the basic control model may be provided for each type of the robot 7, or may be provided according to the type of cooperative activity performed by the robot 7. For example, the basic control model corresponding to the type of the cooperative activity performed by the robot 7 may be stored in the basic model storage unit 21, and the user 5 may select the basic control model corresponding to the type of the cooperative activity performed by the robot 7 together with the user 5. Alternatively, an external server or the like may provide the basic control model according to the type of the cooperative activity performed by the robot 7, and the user 5 may select and download the basic control model according to the type of the cooperative activity performed by the robot 7 together with the user 5, whereby the basic control model may be stored in the basic model storage unit 21.

The basic control model and the control model include, for example, one or more control parameters for controlling the robot 7. The control parameters include, for example, at least one of parameters for controlling the movement of the robot 7 such as the trajectory, speed, and acceleration of the robot 7, parameters for controlling the way of movement of each part of the robot 7 such as the arm tip and joints of the robot 7, or parameters for controlling the way of speaking of the robot 7 such as the speed of speaking of the robot 7 and the height (frequency) of the sound emitted by the robot 7.

The data acquisition unit 24 acquires the personal action data of the user 5 from the detection device 4, and stores the acquired personal action data in the data storage unit 23. As described above, in order to obtain the personal action data, processing such as image processing on the video acquired by the detection device 4 and voice recognition processing on the voice acquired by the detection device 4 may be performed. In this case, another device (not illustrated) performs these processing, and the data acquisition unit 24 acquires the personal action data from that device. In addition, the data acquisition unit 24 may perform extraction processing such as image processing on the video acquired by the detection device 4 and voice recognition processing on the voice acquired by the detection device 4. In this case, the data acquisition unit 24 may perform the extraction processing on the data acquired from the detection device 4 and store the processed data in the data storage unit 23 as personal action data, or may store the data itself acquired from the detection device 4 in the data storage unit 23 as personal action data and the learning unit 22 may perform the extraction processing in the processing of generating the control model to be described later. Here, the data acquisition unit 24 receives the personal action data to acquire the personal action data, but the present disclosure is not limited thereto, and the personal action data may be recorded in a recording medium or the like. In this case, the data acquisition unit 24 acquires the personal action data by reading the personal data from the recording medium.

The correction information storage unit 25 stores correction information indicating a correction content for the basic control model according to the personal action data. The correction information is, for example, information in which one or more features indicated by the personal action data are associated with the correction content. The feature indicates the personality of the person whose personal action data is to be acquired. The personality includes, for example, at least one of the behavior, habitual saying, intonation, dialect, or habit of movement. The correction content is determined such that the robot 7 performs an activity that does not cause stress when the user 5 performs a cooperative activity with the robot 7 according to the personality of the user 5. The learning unit 22 uses the personal action data stored in the data storage unit 23, that is, the accumulated personal action data, to generate a control model of the robot 7 for the robot 7 to perform a cooperative activity with the user 5, the control model reflecting the personality of the user 5. The learning unit 22 generates the control model by using, for example, the basic control model stored in the basic model storage unit 21, the personal action data accumulated in the data storage unit 23, and the correction information stored in the correction information storage unit 25.

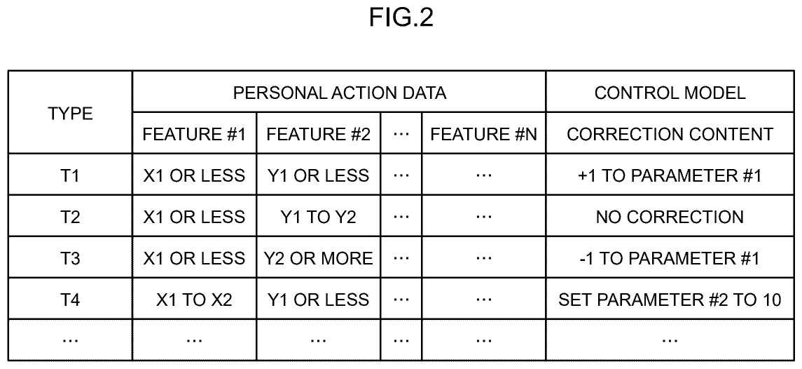

FIG. 2 is a diagram illustrating an example of correction information according to the present embodiment. In the example illustrated in FIG. 2, individuality of the user 5 is classified into types on the basis of N (N is an integer of one or more) features, and the correction information includes correction contents of parameters (control parameters) in the control model for each type. The feature may indicate the direction of movement of the user 5 at the time of the cooperative activity by an angle from the reference direction, may indicate the amount of movement of the user 5 from the reference point at the time of the cooperative activity by a numerical value, may be information obtained by frequency conversion of time-series data of the position of the user 5 at the time of the cooperative activity, may be the speaking speed of the user 5, or may be information obtained by frequency conversion of the voice of the user 5. Furthermore, the feature may be whether the user 5 has performed a specific predetermined motion, may be the number of times the user 5 has performed a specific predetermined motion in a unit time, may be whether the user 5 has uttered a specific word, or may be the number of times per unit time of a specific word uttered by the user 5. Furthermore, as the feature indicating the habit or personality of the user 5, for example, behavior having a specific regularity may be extracted from among behaviors that significantly tend to differ between individuals. In addition, the feature may be the personal action data itself or the cooperative activity data itself in the personal action data. The feature is not limited to the above example as long as the feature indicates the way of movement and/or the way of speaking of the user 5, that is, the habit of the user 5. Note that FIG. 2 illustrates an example in which N is three or more, but the present disclosure is not limited thereto, and N may be one or more.

In FIG. 2, an example in which the correction information is determined in a table format has been described, but the format of the correction information is not limited to the example illustrated in FIG. 2. When the correction information illustrated in FIG. 2 is used, the learning unit 22 extracts a feature from the personal action data accumulated in the data storage unit 23, identifies a type corresponding to the extracted feature using the correction information, extracts a correction content corresponding to the identified type from the correction information, and corrects the basic control model on the basis of the extracted correction content, thereby generating the control model.

The correction information may be manually determined in advance. For example, the correction information may be determined by a vendor, an administrator, or the like of the robot 7 or the control system 1, or may be determined by being learned by machine learning (preliminary learning).

In the former case, the vendor or the administrator estimates how to correct the motion of the robot 7 based on the basic control model for each type of the user 5 so that the user 5 does not feel stress according to the content of the cooperative activity, whereby the correction information is determined.

In the latter case, for example, before the operation of the robot 7 is started, the robot 7 is caused to perform a cooperative activity with an arbitrary person, and for each cooperative activity, a feature extracted from personal action data of a person who has performed the cooperative activity and correction contents (correction contents from the basic control model) of each control parameter in the control model of the robot 7 are acquired as a data set. Further, in each cooperative activity, an evaluation indicating whether a person who has performed the cooperative activity with the robot 7 feels stress is performed. The activity of the robot 7 and the person performing the cooperative activity are appropriately changed, and a plurality of data sets having different conditions and corresponding evaluation results are acquired. Note that any person may perform the cooperative activity at this time, and the user 5 may or may not be included. Furthermore, the robot 7 that performs the cooperative activity at this time does not have to be the robot 7 itself that performs the cooperative activity with the user 5, and may be another robot of the same type as the robot 7 or another type of robot capable of performing the same operation as the robot 7.

When a plurality of data sets having different conditions and evaluation results that are corresponding correct answer data are acquired, a learned model is generated by supervised learning by using, as correct answer data, correction contents of each control parameter in a data set from which an evaluation result indicating that no stress is felt by preliminary learning is obtained. The preliminary learning may be performed by the learning unit 22, may be performed by a preliminary learning unit (not illustrated) of the control model generation unit 2, or may be performed by a learning device different from the control system 1. In a case where the preliminary learning is performed, the correction information is a learned model for inferring the correction content of the control parameter from the feature extracted from the personal action data, and the learning unit 22 can infer the correction content of the control parameter suitable for the user 5 by inputting the feature extracted from the personal action data of the user 5 to the learned model. The learning unit 22 generates the control model by reflecting the inferred correction content in the basic control model.

Any algorithm may be used as the supervised learning algorithm, and for example, a neural network model can also be used. A neural network includes an input layer composed of a plurality of neurons, an intermediate layer (hidden layer) composed of a plurality of neurons, and an output layer composed of a plurality of neurons. The number of intermediate layers may be one or two or more.

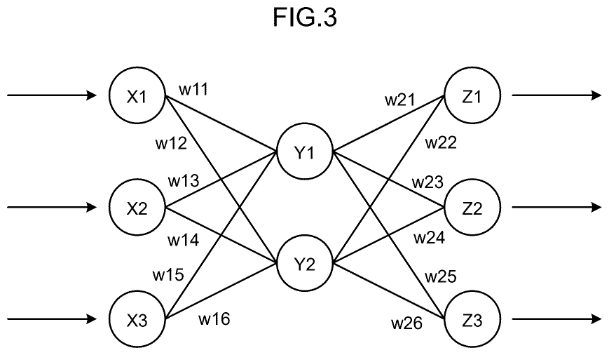

FIG. 3 is a schematic diagram illustrating an example of a neural network. For example, in the case of the three-layer neural network illustrated in FIG. 3, a plurality of inputs are input to input layers (X1 to X3), then the values thereof are multiplied by weights W1 (w11 to w16) and input to intermediate layers (Y1 and Y2), and the results thereof are further multiplied by weights W2 (w21 to w26) and output from output layers (Z1 to Z3). The output results vary depending on the values of the weights W1 and the weights W2.

In the present embodiment, the relationship between the feature and the correct answer data is learned by adjusting the weight W1 and the weight W2 such that the output from the output layer in response to the input of the feature extracted from the personal action data approaches the correction content of the control parameter that is the correct answer data. Note that the machine learning algorithm is not limited to the neural network, and may be another algorithm such as a support vector machine. In addition, the machine learning used for generating the learned model is not limited to supervised learning, and may be reinforcement learning or the like.

Furthermore, in a case where preliminary learning is performed, information in a table format may be used as the correction information. For example, after the above-described learned model is generated, a plurality of pieces of input data are generated by changing the value of each feature, and a control parameter obtained by inputting each piece of input data to the learned model is inferred. Then, the input data in which all the correction contents of the control parameters obtained by the inference are the same or differ within a certain range may be defined as one type, the control parameter for each type may be determined, and the correction information in the table format illustrated in FIG. 2 may be generated.

In addition, even in a case where supervised learning, reinforcement learning, or the like is not used, the activity of the robot 7 and the person performing the cooperative activity are appropriately changed to acquire a plurality of data sets having different conditions, and the correction information may be determined using the acquired data sets and the corresponding evaluation results. For example, the values such as X1 and X2, which are the thresholds for classification into types, and the control parameters may be manually determined by using the correction content of each control parameter in the data set from which an evaluation result indicating that no stress is felt is obtained and the feature of the personal action data.

Furthermore, although the example of using the correction information has been described here, depending on the content of the cooperative activity, overall information indicating the total value of the index obtained by the activity of the robot 7 and the index obtained by the activity of the user 5 in the cooperative activity may be defined instead of the correction information. For example, in a case where the cooperative activity is an activity in which the robot 7 and the user 5 pull an object with a certain force in cooperation with each other, if the pulling force of the user 5 is weak, the cooperative activity fails unless the pulling force of the robot 7 is increased, which causes stress of the user 5. In addition, if the pulling force of the user 5 is strong, unless the pulling force of the robot 7 is weakened, the cooperative activity fails, which causes stress of the user 5. In the case of such cooperative activity, the force pulled by the user 5 is acquired as personal action data, and the total force is defined as overall information.

Then, the learning unit 22 calculates the pulling force of the robot 7 by subtracting the pulling force of the user 5 from the total force, and calculates the correction amount of the control parameter according to the calculated force. The above-described overall information is an example, and the overall information is not limited to the above-described example.

Returning to FIG. 1, the learning unit 22 outputs the generated control model to the robot control unit 3. The robot control unit 3 includes an instruction transmission unit 31, a situation acquisition unit 32, a control instruction generation unit 33, and a control model storage unit 34. The robot control unit 3 is an example of an activity control unit (activity control device) that controls the humanoid.

The control model storage unit 34 stores the control model output from the learning unit 22. The situation acquisition unit 32 acquires the situation data indicating the situation of the cooperative activity between the robot 7 and the user 5 acquired by the situation detection device 8 by receiving the situation data from the situation detection device 8, and outputs the acquired situation data to the control instruction generation unit 33. The situation detection device 8 may be provided in the robot 7, may be provided around the robot 7, or may be provided both in the robot 7 and around the robot 7. The situation detection device 8 acquires situation data that is used for controlling the robot 7 according to the type of the robot 7 and the content of the cooperative activity. The situation detection device 8 may acquire the situation of the activity of the user 5 such as the voice uttered by the user 5 and the motion of the user 5. A plurality of situation detection devices 8 may be provided. The situation detection device 8 may be, for example, an imaging device that detects the position of the robot 7, the state around the robot 7, or the like, or may be an acceleration sensor, a force sensor, or the like. In addition, in a case where the robot 7 moves an object that is a target object or applies force to the target object, the situation detection device 8 may be an imaging device or the like for grasping the positional relationship between the handled object and the robot 7. The situation detection device 8 may be two or more of these or may be others, and any sensor generally used for controlling the robot 7 can be used. Note that the situation data may not be used for controlling the robot 7, and in this case, the situation detection device 8 may not be provided.

The control instruction generation unit 33 generates a control instruction for the robot 7 using the situation data received from the situation acquisition unit 32 and the control model stored in the control model storage unit 34, and outputs the generated control instruction to the instruction transmission unit 31. The instruction transmission unit 31 transmits the control instruction received from the control instruction generation unit 33 to the robot 7. The robot 7 that has received the control instruction operates on the basis of the control instruction.

As described above, in the present embodiment, the control model is generated by the learning unit 22 using the personal action data at the time when the user 5 is performing the cooperative activity with the cooperative activity target person 6 familiar with the user 5, and the control instruction based on the generated control model is transmitted to the robot 7. Since the control model is generated before the cooperative activity between the user 5 and the robot 7, the robot 7 can perform an activity that is the same as or similar to the activity of the cooperative activity target person 6 from the start of the cooperative activity, and can reduce the stress of the user 5 due to the action and/or the way of speaking of the robot 7 in the cooperative activity.

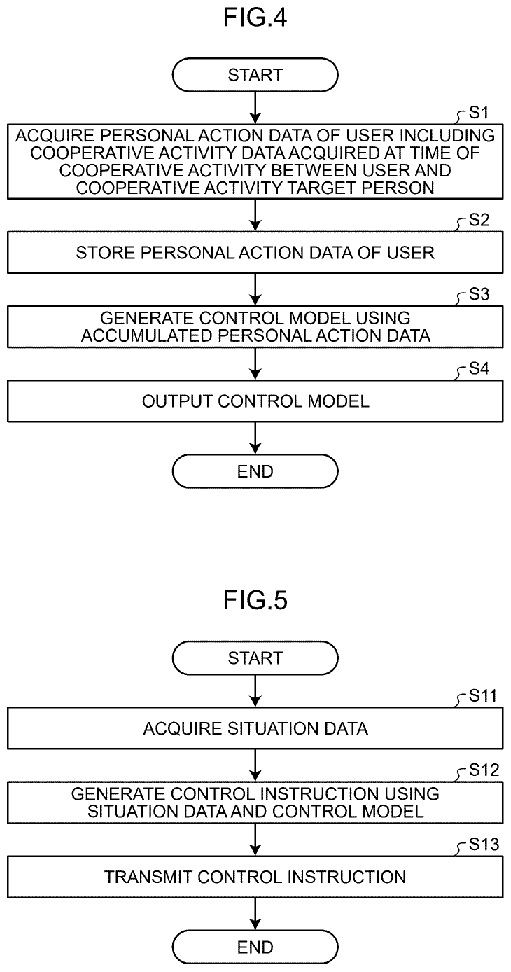

Next, operations according to the present embodiment will be described. FIG. 4 is a flowchart illustrating an exemplary procedure in the control model generation unit 2 according to the present embodiment. The control model generation unit 2 acquires personal action data of the user 5 including the cooperative activity data acquired at the time of the cooperative activity between the user 5 and the cooperative activity target person 6 (step S1). Specifically, the data acquisition unit 24 acquires the personal action data of the user 5 by receiving the personal action data from the detection device 4. Note that, as described above, the data acquisition unit 24 may acquire the personal action data using a recording medium. In addition, a video or the like that is a source of the personal action data may be acquired by the detection device 4 and the extraction processing may be performed.

The control model generation unit 2 stores the personal action data of the user 5 (step S2). Specifically, the data acquisition unit 24 stores the received personal action data in the data storage unit 23.

The control model generation unit 2 generates a control model using the accumulated personal action data (step S3). Specifically, the learning unit 22 extracts the feature using the personal action data of the user 5 stored in the data storage unit 23, and generates the control model using the feature and the basic control model stored in the basic model storage unit 21. Note that the accumulated personal action data is personal action data acquired for each cooperative activity in one or more cooperative activities. In a case where the feature is, for example, the speaking speed of the user 5, in a case where personal action data corresponding to a plurality of times of cooperative activities is accumulated, an average speed per character may be obtained using all the personal action data corresponding to the plurality of times of cooperative activities. For example, in a case where the feature indicates the movement tendency of the user 5, an averaged position at a predetermined time point in the cooperative activity may be calculated using personal action data corresponding to a plurality of times of cooperative activities, and a difference between the averaged position and a predetermined standard position may be used as the feature. The method of calculating the feature is not limited to the above-described example.

The control model generation unit 2 outputs the control model (step S4). Specifically, the learning unit 22 outputs the generated control model to the robot control unit 3. The control model storage unit 34 of the robot control unit 3 stores the control model output from the learning unit 22.

FIG. 5 is a flowchart illustrating an exemplary procedure in the robot control unit 3 according to the present embodiment. The processing illustrated in FIG. 5 is performed when the robot 7 and the user 5 perform the cooperative activity after the control model is generated by the control model generation unit 2.

The robot control unit 3 acquires the situation data (step S11). Specifically, the situation acquisition unit 32 acquires the situation data indicating the situation of the robot 7 acquired by the situation detection device 8 by receiving the situation data from the situation detection device 8, and outputs the acquired situation data to the control instruction generation unit 33.

The robot control unit 3 generates a control instruction using the situation data and the control model (step S12). Specifically, the control instruction generation unit 33 generates a control instruction for the robot 7 using the situation data received from the situation acquisition unit 32 and the control model stored in the control model storage unit 34, and outputs the generated control instruction to the instruction transmission unit 31.

The robot control unit 3 transmits a control instruction (step S13). Specifically, the instruction transmission unit 31 transmits the control instruction received from the control instruction generation unit 33 to the robot 7. As a result, the robot 7 performs an activity that is based on the control instruction.

Note that, in a case where the user 5 and the cooperative activity target person 6 perform the cooperative activity after the control model is once generated and the robot 7 and the user 5 perform the cooperative activity, the cooperative activity data in the cooperative activity may be acquired, and the control model may be generated on the basis of the personal action data including the acquired cooperative activity data. In this case, the processing illustrated in FIG. 5 is performed using the newly generated control model. As described above, once the control model is generated, the control model may be updated using new cooperative activity data. As a result, even when the personality of the user 5 changes, the robot 7 can be controlled by reflecting the latest state.

Next, an example of the cooperative activity performed using the cooperative activity system 100 of the present embodiment will be described. First, as a first example of the cooperative activity, a case where the robot 7 is a serving robot of a restaurant will be described. In the first example, the cooperative activity is serving work. For example, A, B, C, and D both work at the same restaurant, and B may serve food together with A, may serve food together with C, or may serve food together with D. Assume that B is able to perform the work well when performing the serving work together with A, and is also able to perform the work well when performing the assembly work together with C. On the other hand, assume that in a case where B performs the serving work together with D, B cannot comfortably perform the serving work and feels stress. A and C are scheduled to leave the company, and after A and C leave, B is scheduled to perform the serving work together with the robot 7. In such a case, in preparation for the cooperative activity with the robot 7, personal action data including the cooperative activity data at the time when B who is the user 5 is performing the cooperative activity with the cooperative activity target person 6 is acquired. In this case, the cooperative activity target persons 6 familiar with the cooperative activity with B are A and C.

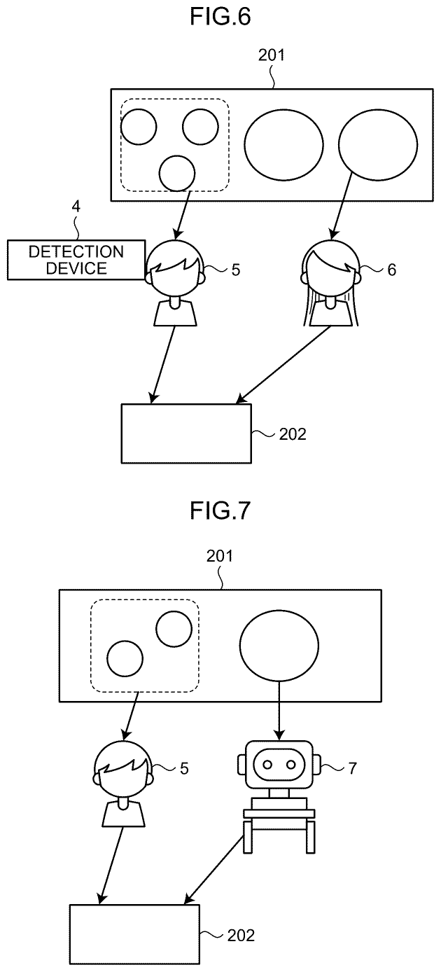

FIG. 6 is a schematic diagram illustrating an example of acquisition of personal action data in the first example. In the example illustrated in FIG. 6, the user 5 and the cooperative activity target person 6 serve the plates placed at a serving counter 201 to a table 202 in the hall of the restaurant. As illustrated in FIG. 6, in the restaurant, when the user 5 (B) is performing the serving work together with the cooperative activity target person 6 (A or C), the personal action data of B is acquired by the detection device 4. For example, as illustrated in FIG. 6, when the user 5 is performing the serving work together with the cooperative activity target person 6, the user 5 serves a plurality of small plates, and the cooperative activity target person 6 serves a large plate. On the other hand, assume that in a case where the user 5 performs the serving work together with D, D serves a plurality of small plates and B serves a large plate.

In the example illustrated in FIG. 6, the personal action data includes information indicating which plate has been served. For example, on the serving counter 201 on which the dish made in the kitchen is temporarily placed before serving, in a case where the positions where small plates and large plates are placed are substantially determined in advance, the time-series data of the position detected by the detection device 4 may be treated as the personal action data by using the detection device 4 that detects the position of the user 5. In this case, for example, the learning unit 22 may obtain the history of the movement of the user 5, and obtain the size of the plate served by the user 5 as the feature on the basis of the obtained history and the position where small plates and large plates are placed. Alternatively, the size and number of plates served by the user 5 may be calculated by the data acquisition unit 24 or another device as the personal action data by analyzing the video captured by the detection device 4 using the detection device 4 capable of capturing the serving counter 201. Alternatively, the video captured by the detection device 4 using the detection device 4 capable of capturing the serving counter 201 may be set as the personal action data, and the learning unit 22 may obtain the size of the plate served by the user 5 from the video as the feature.

The first example is based on the premise that a large plate and a small plate are included as plates to be served in the serving work. Therefore, the size of the serving plate or the size and number of serving plates are included as the feature, and a type of serving a plurality of small plates or a type of serving a large plate is defined as the type in the correction information. Then, as the correction content corresponding to the type in the correction information, a numerical value is set to be a control parameter for setting a target to be served by the robot 7 to a large plate. For example, in the first example, the control model includes a serving determination model and a movement model, and the serving determination model includes a definition of the size of a plate to be served by the robot 7. Then, as a correction content corresponding to the above-described type in the correction information, information for setting a control parameter is set for setting a serving target to a plate having a diameter of a certain value or more. As a result, the learning unit 22 of the control model generation unit 2 can generate a control model that causes the robot 7 to serve the large plate. In addition, in a case where the positions where small plates and large plates are placed on the serving counter 201 are substantially determined in advance, instead of specifying the size of the plate, the range in which the plate to be served exists on the serving counter 201 may be set as the control parameter.

FIG. 7 is a schematic diagram illustrating an example of a cooperative activity between the user 5 and the robot 7 in the first example. In the example illustrated in FIG. 7, as described with reference to FIG. 6, since the control model for causing the robot 7 to serve the large plate is generated, the robot 7 serves the large plate. As a result, the user 5 can reduce the stress and efficiently perform the serving work as in the case of performing the serving work together with A or C who is the cooperative activity target person 6. As described above, in the first example, the control system 1 can learn a serving method by which B who is the user 5 can efficiently act, and generate a control model reflecting the learned result.

Next, as a second example of the cooperative activity, a case where the robot 7 and the user 5 perform assembly work will be described. In the second example, the robot 7 is, for example, an assembly robot that is a type of industrial machine. For example, A, B, C, and D are workers who perform assembly work together, and B may perform assembly work together with A, may perform assembly work together with C, or may perform assembly work together with D. Assume that B is able to perform the work well when performing the assembly work together with A, and is also able to perform the work well when performing the assembly work together with C. On the other hand, assume that in a case where B performs the assembly work together with D, B who is the user 5 cannot comfortably perform the assembly work and feels stress. A and C are scheduled to transfer, and after the transfer of A and C, B is scheduled to perform assembly work together with the robot 7. In such a case, as in the first example, in preparation for the cooperative activity with the robot 7, personal action data including the cooperative activity data at the time when B who is the user 5 is performing the cooperative activity with the cooperative activity target person 6 is acquired. In this case, the cooperative activity target persons 6 familiar with the cooperative activity with B are A and C.

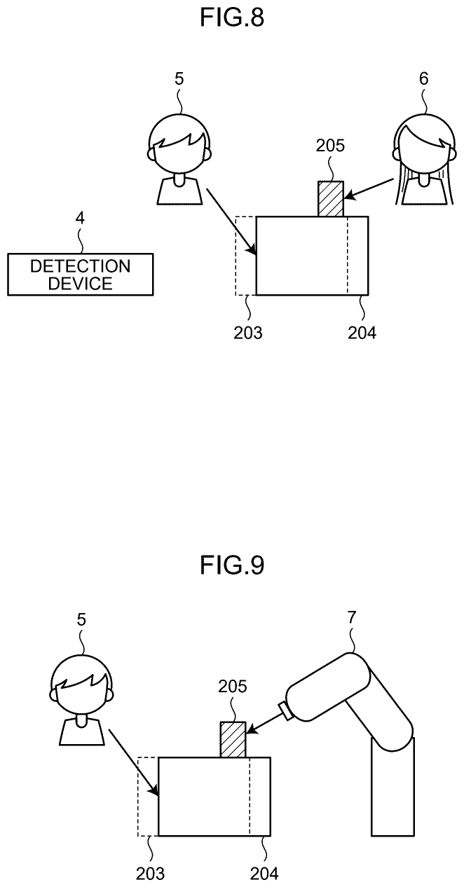

FIG. 8 is a schematic diagram illustrating an example of acquisition of personal action data in the second example. In the example illustrated in FIG. 8, the user 5 and the cooperative activity target person 6 perform the assembly work in cooperation. More specifically, the user 5 (B) places a first component 204, and the cooperative activity target person 6 (A or C) disposes a second component 205 on the first component 204. A standard position 203 indicates a standard position where the first component 204 is placed, and the user 5 has a habit of placing the first component 204 on the right in FIG. 8 relative to the standard position. The cooperative activity target person 6 familiar with the user 5 disposes the second component 205 in accordance with the position where the user 5 places the first component 204, so that the assembly work can be efficiently performed. On the other hand, D, who is not familiar with the user 5, tries to dispose the second component 205 on the assumption that the first component 204 is placed at the standard position 203. Therefore, it takes time for positioning, or the user 5 needs to change the position of the first component 204, so that the assembly work cannot be efficiently performed, and the user 5 feels stress.

In such a case, the position where the user 5 places the first component 204 or the position of the hand of the user 5 at the time when the user 5 places the first component 204 is detected by the detection device 4. Then, using the difference of the first component 204 from the standard position 203 as the feature, a type in which the placement position of the first component 204 is shifted from the standard position 203 by a threshold or more is defined in the correction information. Then, as the correction content corresponding to the type in the correction information, the content of determining the control parameter so as to shift the position of the second component 205 disposed by the robot 7 by the same amount as the difference between the placement position of the first component 204 and the standard position 203 is included. As a result, the learning unit 22 of the control model generation unit 2 can generate a control model that causes the robot 7 to dispose the second component 204 according to the amount by which the user 5 has shifted the first component 205 from the standard position 203.

FIG. 9 is a schematic diagram illustrating an example of a cooperative activity between the user 5 and the robot 7 in the second example. In the example illustrated in FIG. 9, as described with reference to FIG. 8, since the control model for causing the robot 7 to dispose the second component 204 according to the amount by which the user 5 has shifted the first component 205 from the standard position 203 is generated, the robot 7 disposes the second component 205 to be shifted to the right. As a result, the user 5 can reduce the stress and efficiently perform the assembly work as in the case of performing the assembly work together with A or C who is the cooperative activity target person 6.

In both the first example and the second example, the robot 7 can work together with the user 5 by consideration of the behavior of B who is the user 5, and even in an environment for labor saving in which a person and the robot 7 which is an example of a humanoid work together, the user 5 can perform a cooperative activity in a state in which stress such as difficulty in working and discomfort is reduced. Note that the cooperative activity performed using the cooperative activity system 100 described above is an example, and the cooperative activity performed using the cooperative activity system 100 is not limited to the example described above.

Note that the cooperative activity is not limited to being performed by two persons, and may be performed by three or more persons. For example, in the case of the cooperative activity performed by three persons, two robots 7 may be used, or the robot 7 and the cooperative activity target person 6 may perform the cooperative activity together with the user 5. In this case, for example, assuming that B and A do not feel stress when B who is the user 5 performs the cooperative activity with A and C, a control model is generated on the basis of the personal action data of C, and the robot 7 is controlled on the basis of this control model.

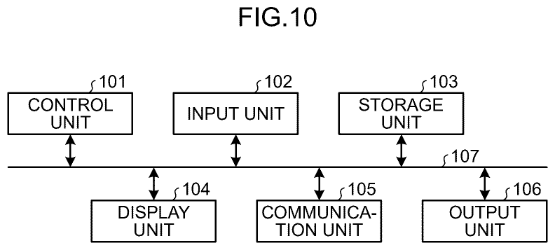

Next, a hardware configuration of each device according to the present embodiment will be described. In the control system 1 according to the present embodiment illustrated in FIG. 1, a program that is a computer program describing the processes in the control system 1 is executed on a computer system, so that the computer system functions as the control system 1. FIG. 10 is a diagram illustrating an exemplary configuration of a computer system that implements the control system 1 according to the present embodiment. As illustrated in FIG. 10, this computer system includes a control unit 101, an input unit 102, a storage unit 103, a display unit 104, a communication unit 105, and an output unit 106, which are connected to one another via a system bus 107. The control unit 101 and the storage unit 103 constitute processing circuitry.

In FIG. 10, the control unit 101 is, for example, a processor such as a central processing unit (CPU), and executes a program describing the processes in the control system 1 according to the present embodiment. Note that a part of the control unit 101 may be implemented by dedicated hardware such as a graphics processing unit (GPU) or a field-programmable gate array (FPGA). The input unit 102 may be an input means such as a button, a keyboard, a mouse, a joystick, a touch pad, or a game controller. The storage unit 103 includes various types of memories such as a random access memory (RAM) and a read only memory (ROM) and a storage device such as a hard disk. The storage unit 103 stores, for example, programs to be executed by the control unit 101 and necessary data obtained during processing. The storage unit 103 is also used as a temporary storage area for programs. As described above, the display unit 104 is, for example, a display or the like. Note that the display unit 104 and the input unit 102 may be integrated and implemented by a touch panel or the like. The communication unit 105 is a receiver and a transmitter that perform communication processing. The output unit 106 is a speaker or the like. Note that FIG. 10 is an example, and the configuration of the computer system is not limited to the example illustrated in FIG. 10. For example, in the present embodiment, the computer system that implements the control system 1 may not include the output unit 106.

Here, an example of how the computer system operates until the program according to the present embodiment becomes executable will be described. In the computer system having the above-mentioned configuration, for example, the computer program is installed on the storage unit 103 from a compact disc (CD)-ROM or digital versatile disc (DVD)-ROM set in a CD-ROM drive or DVD-ROM drive (not illustrated). Then, when the program is executed, the program read from the storage unit 103 is stored in the main storage area of the storage unit 103. In this state, the control unit 101 executes the processes as the control system 1 according to the present embodiment in accordance with the program stored in the storage unit 103.

In the above description, the program describing the processes in the control system 1 is provided using a CD-ROM or DVD-ROM as a recording medium. Alternatively, the program may be provided by a transmission medium such as the Internet according to the configuration of the computer system, the capacity of the program, and the like.

The program of the present embodiment causes, for example, the computer system to execute: a step of accumulating personal action data that is data related to the activity of a person who has performed a cooperative activity; and a step of generating, using the accumulated personal action data, a control model that is a control model of the humanoid for the humanoid to perform the cooperative activity with the user 5 and that reflects the personality of the person.

The learning unit 22 and the control instruction generation unit 33 illustrated in FIG. 1 are implemented by the control unit 101 illustrated in FIG. 10 executing a computer program stored in the storage unit 103 illustrated in FIG. 10. The storage unit 103 illustrated in FIG. 10 is also used to implement the learning unit 22 and the control instruction generation unit 33 illustrated in FIG. 1. The data acquisition unit 24, the instruction transmission unit 31, and the situation acquisition unit 32 illustrated in FIG. 1 are implemented by the communication unit 105 illustrated in FIG. 10. Furthermore, the data acquisition unit 24 may be implemented by a device that reads a recording medium. The basic model storage unit 21, the data storage unit 23, the correction information storage unit 25, and the control model storage unit 34 illustrated in FIG. 1 are a part of the storage unit 103 illustrated in FIG. 10.

The control system 1 illustrated in FIG. 1 may be implemented by a plurality of computer systems. For example, the control system 1 may be implemented by a cloud system. In addition, as described above, the control model generation unit 2 and the robot control unit 3 may be configured as individual devices, and also in this case, the individual devices may be implemented by a plurality of computer systems.

As described above, before the cooperative activity between the robot 7 and the user 5 is performed, the cooperative activity system 100 of the present embodiment generates a control model for controlling the robot 7 using the personal action data of the user 5 including cooperative activity data acquired when the user 5 and the cooperative activity target person 6 perform the cooperative activity. The robot 7 can perform an activity that is the same as or similar to the activity of the cooperative activity target person 6 from the start of the cooperative activity, and can reduce the stress of the user 5 due to the action and/or the way of speaking of the robot 7 in the cooperative activity.

### Second Embodiment

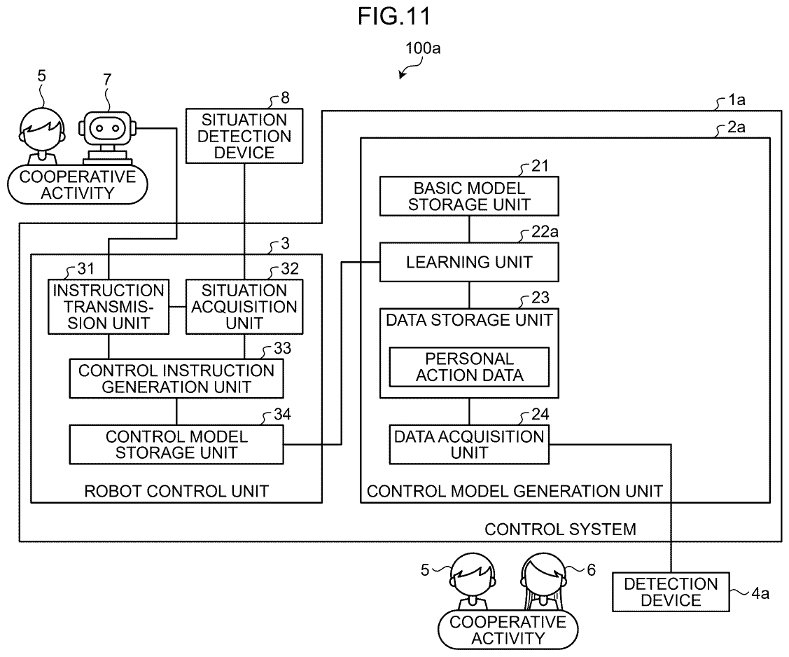

FIG. 11 is a diagram illustrating an exemplary configuration of a cooperative activity system according to the second embodiment. The cooperative activity system 100a of the present embodiment is similar to the cooperative activity system 100 of the first embodiment except that a control system 1a is provided instead of the control system 1 and a detection device 4a is provided instead of the detection device 4. Components having the same functions as those in the first embodiment are denoted by the same reference signs as those in the first embodiment, and redundant explanations are omitted. Hereinafter, differences from the first embodiment will be mainly described.

In the first embodiment, the control model is generated using the personal action data of the user 5 including the cooperative activity data acquired when the user 5 and the cooperative activity target person 6 are performing the cooperative activity. In the present embodiment, the control model is generated using the personal action data of the cooperative activity target person 6 including the cooperative activity data acquired when the user 5 and the cooperative activity target person 6 are performing the cooperative activity. In the present embodiment, the personal action data that is data related to the activity of the person who has performed the cooperative activity is the personal action data of the cooperative activity target person 6. That is, the person whose personal action data is to be acquired is the user 5 in the first embodiment, and is the cooperative activity target person 6 in the present embodiment. Similarly to the first embodiment, the cooperative activity target person 6 is a person with which the user 5 is familiar, and is a person from whom the user 5 is less likely to feel stress when performing the cooperative activity together.

The detection device 4a acquires the personal action data of the cooperative activity target person 6 and transmits the personal action data to the control system 1a. Note that, as in the first embodiment, the personal action data may include biological information or psychological or internal information such as emotion of the cooperative activity target person 6. The detection device 4a itself is similar to the detection device 4 of the first embodiment, but the target of acquisition of the personal action data is the cooperative activity target person 6. The detection device 4a may be a wearable terminal that can be worn by the cooperative activity target person 6, may be a portable terminal that can be carried by the cooperative activity target person 6, may be a device installed so as to be able to detect the activity of the cooperative activity target person 6, may be a device that detects an activity in a virtual space such as metaverse, may be a combination of these, or may be other than these. That is, the personal action data includes, for example, data acquired by the wearable terminal and/or data in which the activity of a person in the virtual space is recorded.

The control system 1a is similar to the control system 1 of the first embodiment except that a control model generation unit 2a is provided instead of the control model generation unit 2. The control model generation unit 2a does not include the correction information storage unit 25, but includes a learning unit 22a instead of the learning unit 22, and the acquisition source of the data of the data acquisition unit 24 is the detection device 4a instead of the detection device 4. Except for these, the control model generation unit 2a is similar to the control model generation unit 2 of the first embodiment. Also in the present embodiment, the control model generation unit 2a and the robot control unit 3 may be provided as individual devices.

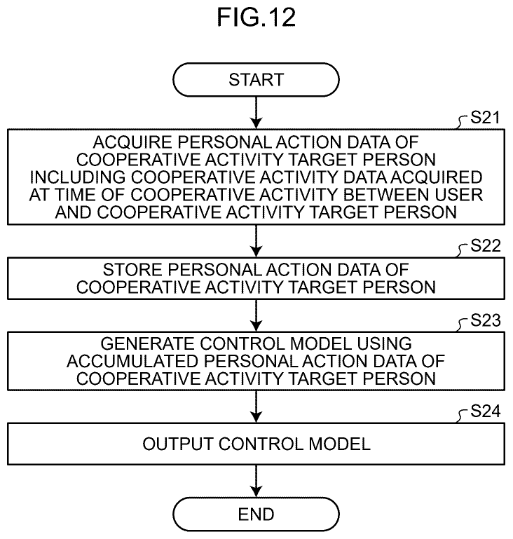

Next, operations of the control model generation unit 2a according to the present embodiment will be described. FIG. 12 is a flowchart illustrating an exemplary procedure in the control model generation unit 2a according to the present embodiment. The control model generation unit 2a acquires personal action data of the cooperative activity target person 6 including the cooperative activity data acquired at the time of the cooperative activity between the user 5 and the cooperative activity target person 6 (step S21). Specifically, the data acquisition unit 24 acquires the personal action data of the cooperative activity target person 6 by receiving the personal action data from the detection device 4. Note that, as in the first embodiment, the data acquisition unit 24 may acquire the personal action data using a recording medium. In addition, a video or the like that is a source of the personal action data may be acquired by the detection device 4a and the extraction processing may be performed.

The control model generation unit 2a stores the personal action data of the cooperative activity target person 6 (step S22). Specifically, the data acquisition unit 24 stores the received personal action data in the data storage unit 23.

The control model generation unit 2a generates a control model using the accumulated personal action data of the cooperative activity target person 6 (step S23). Specifically, the learning unit 22a extracts the feature using the personal action data of the cooperative activity target person 6 stored in the data storage unit 23, and generates the control model based on the feature.

In the present embodiment, the control parameters in the control model are set such that the robot 7 performs the activity indicated as the feature. As a result, a control model for causing the robot 7 to perform an activity similar to the activity reflecting the personality of the cooperative activity target person 6 is generated. As the feature, a feature similar to that in the first embodiment can be used, but in the present embodiment, information regarding the dialect, habit of speaking (including habitual saying), topic provision (favorite genre), or the like may be used as the feature. The information regarding the dialect includes, for example, information regarding whether the speaker has a dialect, and if the speaker has a dialect, information regarding the type of the dialect (area). For example, the identification of the dialect may be performed by storing a dictionary of a dialect in advance for each type of dialect and using the dictionary, or may be performed with another method. Examples of the habit of speaking include, but are not limited to, how to use intonation such as frequently using a specific phrase at the end of a sentence, frequently speaking a specific phrase, or making the end of a sentence higher, the pitch of the voice, and the speed of conversation. For example, the learning unit 22a extracts these habits of speaking by performing voice recognition processing on voice data obtained as personal action data of the cooperative activity target person 6.

Step S24 after step S23 is similar to that in the first embodiment, and the learning unit 22a outputs the generated control model to the robot control unit 3. The output control model is stored in the control model storage unit 34 of the robot control unit 3. The operation of the robot control unit 3 is similar to that in the first embodiment. In the present embodiment, the control model is generated so as to perform the activity reflecting the personality of the cooperative activity target person 6 on the basis of the personal action data of the cooperative activity target person 6. As a result, in the cooperative activity with the user 5, the robot 7 can perform the activity reflecting the personality of the cooperative activity target person 6 with which the user 5 is familiar, and can reduce the stress of the user 5 due to the action and/or the way of speaking of the robot 7 in the cooperative activity.

Next, an example of the cooperative activity performed using the cooperative activity system 100a of the present embodiment will be described. As an example, an example in which the robot 7 is a communication robot and the cooperative activity is a conversation will be described. A and B are a married couple, and B is familiar with conversation with A, and is less likely to feel stress when talking with A. A is scheduled to be transferred to overseas alone, and during the unaccompanied assignment of A, B is scheduled to have a conversation with the robot 7. In this case, the user 5 of the robot 7 is B, A is set as the cooperative activity target person 6, and the personal action data of A is acquired. The control model generation unit 2a generates a control model on the basis of the accumulated personal action data of A. For example, the basic control model includes a conversation model and a voice model, and the conversation model and the voice model are corrected so as to have characteristics similar to the characteristics of A on the basis of the personal action data. As a result, for example, a control model reflecting the habitual saying, intonation, dialect, way of responding, topic provision, and the like of A is generated.

In a case where B who is the user 5 has a conversation with the robot 7 as a cooperative activity during the unaccompanied assignment of A, the robot 7 is controlled using the control model based on the personal action data of A described above. As a result, the robot 7 can have a conversation reflecting the personality of A, and can reduce the stress of B who is the user 5. Note that the cooperative activity performed using the cooperative activity system 100a described above is an example, and the cooperative activity performed using the cooperative activity system 100a is not limited to the example described above.

The control system 1a of the present embodiment is implemented by a computer system similarly to the control system 1 of the first embodiment. The control system 1a of the present embodiment may also be implemented by a plurality of computer systems, for example, may be implemented by a cloud system. In addition, as described above, the control model generation unit 2a and the robot control unit 3 may be configured as individual devices, and also in this case, the individual devices may be implemented by a plurality of computer systems.

Note that the cooperative activity is not limited to being performed by two persons, and may be performed by three or more persons. For example, in the case of the cooperative activity performed by three persons, two robots 7 may be used, or the robot 7 and the cooperative activity target person 6 may perform the cooperative activity together with the user 5. In this case, for example, assuming that B who is the user 5 does not feel stress when performing the cooperative activity with A and C, control models are generated based on the personal action data of A and C, and the two robots 7 are controlled based on the respective control models. Furthermore, in a case where the robot 7 and the cooperative activity target person 6 perform the cooperative activity together with the user 5, when the cooperative activity target person 6 performing the cooperative activity is A, the robot 7 may be controlled on the basis of the control model corresponding to C, and when the cooperative activity target person 6 performing the cooperative activity is C, the robot 7 may be controlled on the basis of the control model corresponding to A.

As described above, before the cooperative activity between the robot 7 and the user 5 is performed, the cooperative activity system 100a of the present embodiment generates a control model for controlling the robot 7 using the personal action data of the cooperative activity target person 6 including cooperative activity data acquired when the user 5 and the cooperative activity target person 6 perform the cooperative activity. The robot 7 can perform an activity that is the same as or similar to the activity of the cooperative activity target person 6 from the start of the cooperative activity, and can reduce the stress of the user 5 due to the action and/or the way of speaking of the robot 7 in the cooperative activity.

### Third Embodiment

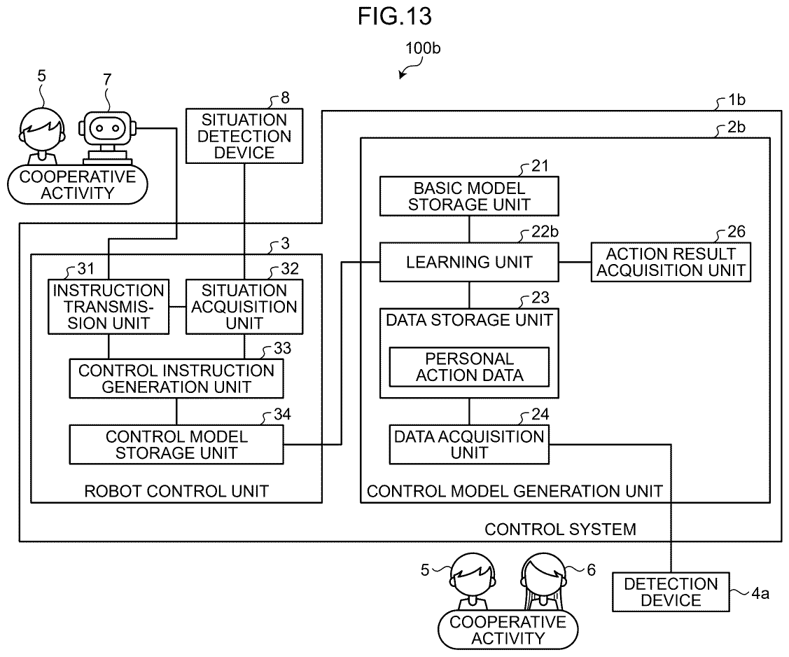

FIG. 13 is a diagram illustrating an exemplary configuration of a cooperative activity system according to the third embodiment. The cooperative activity system 100b of the present embodiment is similar to the cooperative activity system 100a of the second embodiment except that a control system 1b is provided instead of the control system 1a. Components having the same functions as those in the second embodiment are denoted by the same reference signs as those in the second embodiment, and redundant explanations are omitted. Hereinafter, differences from the second embodiment will be mainly described.

The control system 1b is similar to the control system 1a of the second embodiment except that a control model generation unit 2b is provided instead of the control model generation unit 2a. The control model generation unit 2b is similar to the control model generation unit 2a of the second embodiment except that an action result acquisition unit 26 is added and a learning unit 22b is included instead of the learning unit 22a. Also in the present embodiment, the control model generation unit 2b and the robot control unit 3 may be provided as individual devices.

Next, operations of the control model generation unit 2b according to the present embodiment will be described. The control model generation processing in the control model generation unit 2b is similar to the processing in the second embodiment described with reference to FIG. 12. In the present embodiment, after the control model is generated, the control model generation unit 2b updates the control model based on the action result that is the result of the cooperative activity performed by the robot 7 and the user 5 and the control model corresponding to the action result. As described in the second embodiment, the control model is generated so as to reduce the stress of the user 5, but in the present embodiment, the activity of the robot 7 can be made more suitable for the user 5 by updating the control model using the action result.

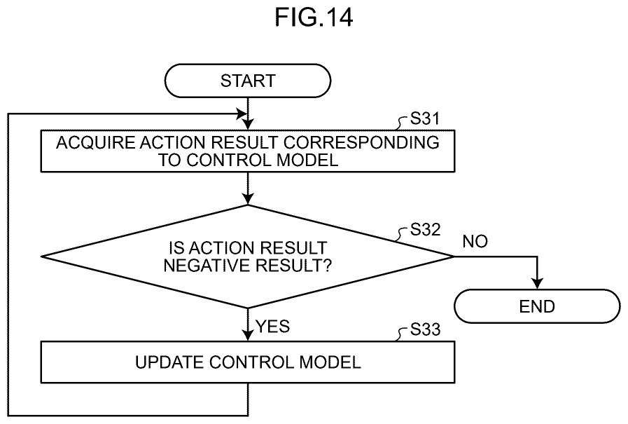

FIG. 14 is a flowchart illustrating an exemplary procedure of control model update processing in the control model generation unit 2b according to the present embodiment. First, the control model generation unit 2b acquires an action result corresponding to the control model (step S31). Specifically, the action result acquisition unit 26 acquires an action result corresponding to the cooperative activity (cooperative activity between the robot 7 and the user 5) performed by the control based on the control model stored in the robot control unit 3, and outputs the acquired action result to the learning unit 22b.

The action result indicates, for example, whether a positive result or a negative result has been obtained. The action result is determined by the user 5, for example, and is input to the control model generation unit 2b. In this case, the action result acquisition unit 26 has a function of receiving an input from the user 5. Alternatively, the user 5 may input the action result to another device such as a user terminal (not illustrated), and that device may transmit the action result to the control model generation unit 2b. In this case, the action result acquisition unit 26 has a communication function of receiving an action result. For example, regarding the cooperative activity with the robot 7, the user 5 sets the action result as a positive result when feeling comfortable in the cooperative activity, feeling no stress, or feeling efficient, and sets the action result as a negative result when feeling stress, feeling uncomfortable, or feeling inefficient.

Furthermore, for example, in a case where the cooperative activity is work or the like, the action result may be determined by another means. For example, in a case where the cooperative activity is the work of a predetermined procedure, the work time of the work is measured, and if the measurement result is equal to or less than the threshold, a person other than the user 5 may determine that the work has been efficiently performed and set the action result as a positive result, and if the measurement result exceeds the threshold, a person other than the user 5 may determine that the work has not been efficiently performed and set the action result as a negative result. Also in this case, the action result may be input to the control model generation unit 2b or may be transmitted from another device. In a case where the work is efficiently performed, it can be estimated that the stress of the user 5 is also low, and thus, the action result may be determined on the basis of the measurement result of the work time in this manner. In addition, the above-described determination based on a measurement result may be made by the control model generation unit 2b. For example, the action result acquisition unit 26 may receive a measurement result from a device that measures work time, and determine an action result using the received measurement result. The method of determining the action result is not limited to the above-described example.

The control model generation unit 2b determines whether the action result is a negative result (step S32). Specifically, the learning unit 22b determines whether the action result received from the action result acquisition unit 26 is a negative result.

If the action result is not a negative result (No in step S32), that is, if the action result is a positive result, the control model generation unit 2b ends the control model update processing.

If the action result is a negative result (Yes in step S32), the control model generation unit 2b updates the control model (step S33) and repeats the processing from step S31. In step S33, specifically, the learning unit 22b updates the control model and outputs the updated control model to the robot control unit 3. As a result, the control model stored in the control model storage unit 34 of the robot control unit 3 is updated. For example, the learning unit 22b updates the control model by changing some of the control parameters in the control model. The method of changing control parameters may be determined in advance or may be designated by the user 5. For example, in a case where the control parameter for changing the position of the robot 7 is updated, a rule for changing the position of the robot 7 may be determined in advance, or the user 5 may designate a direction and an amount to be changed regarding the position of the robot 7.

As described above, in a case where the action result is a negative result, the control model is updated, control using the updated control model is performed, and the processing from step S31 is performed again. In a case where the action result is a negative result, the change of the control parameter is repeated so that a positive result can be obtained as the action result.

In the above example, when the action result is a positive result, the current control model is used as the updated control model without changing the control model. However, the present disclosure is not limited thereto, and the control model may be updated by changing the current control parameter to a control parameter estimated to be better. The control parameter estimated to be better is, for example, a control parameter changed in a direction opposite to the control parameter set when the action result has a negative result before that. For example, if the action result is a negative result when the conversation speed is a first speed, and the action result is a positive result when the conversation speed is changed to a second speed lower than the first speed, the control model may be updated to change the conversation speed to a third speed lower than the second speed. Then, the action result is acquired again, and if the action result is a negative result, the control model is updated to return the conversation speed to the second speed.

Alternatively, the control model update processing is not limited to the procedure illustrated in FIG. 14, and the control parameter may be sequentially changed to acquire the action result corresponding to the value of each control parameter, a data set of the value of the control parameter and the action result corresponding to the value may be stored, and the control model may be updated using a plurality of data sets. For example, data sets in which the action result is a positive result may be extracted, one of the extracted data sets may be selected, and the control model may be updated using the control parameter in the selected data set. In addition, the control model may be updated by setting the action result and the corresponding control parameter as a data set and determining the control parameter that improves the action result by machine learning using a plurality of data sets. For example, the learning unit 22b generates a learned model by the supervised learning described in the first embodiment using a plurality of data sets including an action result and control parameters that are correct answer data corresponding to the action result. Then, at the time of inference, that is, at the time of updating the control model, the learning unit 22b can infer a control parameter that makes the action result positive by inputting a value in which the action result is positive as the action result.

In addition, the action result is not limited to two values of positive and negative, and may be represented by three or more levels of numerical values. For example, the action result may be set as a score from zero to five, and it may be defined that the user 5 feels the least stress when the action result is five, and feels the most stress when the action result is zero. Note that the definition of the score is not limited to this example. In the case of the representation by three or more levels of numerical values, in the processing illustrated in FIG. 14, in step S32, the learning unit 22b may determine whether the action result is a numerical value indicating the most positive. Furthermore, in a case where the control model is updated using the plurality of data sets described above, the learning unit 22b may select a data set in which the action result is a numerical value indicating the most positive.

Furthermore, in the above example, the action result is a result obtained by evaluating the entire control model, but the present disclosure is not limited thereto, and the action result may be a result obtained by dividing the time-series activity of the robot 7. For example, a control instruction to the robot 7 may be recorded in an activity history storage unit (not illustrated), and the action result may be determined, for example, at regular time intervals or at intervals of the activity of the robot 7. In this case, the activity history storage unit may be provided in the robot control unit 3, in the control model generation unit 2b, or outside the control system 1b. In this case, the action result acquisition unit 26 reads and acquires, from the activity history storage unit, a control instruction for a period corresponding to the action result together with the action result, and outputs the control instruction corresponding to the action result to the learning unit 22b. As a result, the learning unit 22b can obtain the action result of the operation in units of the activity of the robot 7 corresponding to the control instruction performed in time series.

For example, assume that, in a case where the cooperative activity is a conversation, a result that topics are often provided for a first genre and a second genre is obtained as the feature of the cooperative activity target person 6 on the basis of the personal action data of the cooperative activity target person 6, and the control model is generated on the basis of the result. At the time of generating the control model, assume that the topic provision frequencies of the first genre and the second genre are set to the same level. In the conversation, the time series includes a period in which the conversation of the first genre is performed and a period in which the conversation of the second genre is performed. Based on the control instruction to the robot 7, these periods are distinguished, and the action result acquisition unit 26 acquires each action result. For example, in a case where the action result of the period of the conversation of the first genre is a positive result and the action result of the period of the conversation of the second genre is a negative result, the control model is updated so as to increase the frequency of the topic provision of the first genre and reduce the frequency of the topic provision of the second genre.

The control model update processing is not limited to the above-described example, and any method may be used as long as the learning unit 22b updates the control model so as to make the control model more suitable for the user 5 on the basis of the action result.

The control system 1b of the present embodiment is implemented by a computer system similarly to the control system 1a of the second embodiment. The control system 1b of the present embodiment may also be implemented by a plurality of computer systems, for example, may be implemented by a cloud system. In addition, as described above, the control model generation unit 2b and the robot control unit 3 may be configured as individual devices, and also in this case, the individual devices may be implemented by a plurality of computer systems.

As described above, the cooperative activity system 100b of the present embodiment performs the operation described in the second embodiment, and also updates the control model on the basis of the action result that is the result of the cooperative activity between the robot 7 and the user 5. Therefore, it is possible to achieve the same effects as those of the second embodiment and to cause the robot 7 to perform an activity more suitable for the user 5.

Note that, in the above-described example, the control model update function is added to the cooperative activity system 100a of the second embodiment, but the present disclosure is not limited thereto, and the control model update function may be added to the cooperative activity system 100 of the first embodiment. For example, by adding the action result acquisition unit 26 to the control model generation unit 2 of the cooperative activity system 100 and providing the learning unit 22 with a control model update function similarly to the learning unit 22b, the control model may be updated similarly to the above-described example.

### Fourth Embodiment

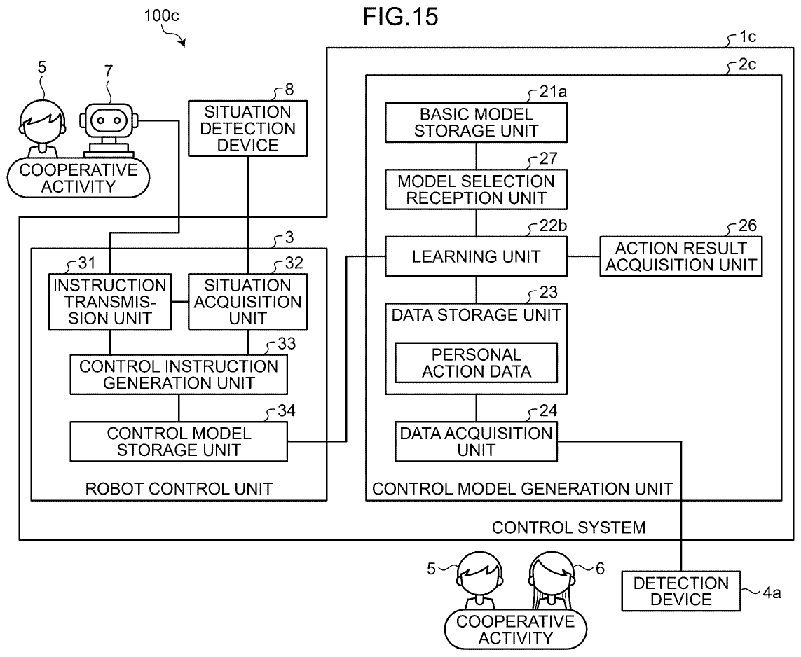

FIG. 15 is a diagram illustrating an exemplary configuration of a cooperative activity system according to the fourth embodiment. The cooperative activity system 100c of the present embodiment is similar to the cooperative activity system 100b of the third embodiment except that a control system 1c is provided instead of the control system 1b. Components having the same functions as those in the third embodiment are denoted by the same reference signs as those in the third embodiment, and redundant explanations are omitted. Hereinafter, differences from the third embodiment will be mainly described.

The control system 1c is similar to the control system 1b of the third embodiment except that a control model generation unit 2c is provided instead of the control model generation unit 2b. The control model generation unit 2c is similar to the control model generation unit 2b of the third embodiment except that a model selection reception unit 27 is added and a basic model storage unit 21a is provided instead of the basic model storage unit 21. Also in the present embodiment, the control model generation unit 2c and the robot control unit 3 may be provided as individual devices.

The basic model storage unit 21a stores a plurality of, that is, a plurality of types of, basic control models in advance. The plurality of types of basic control models can also be said to be a typical pattern that characterizes the cooperative activity target person 6. The typical pattern that characterizes the cooperative activity target person 6 is, for example, a pattern corresponding to the speech and conduct (behavior) based on a typical personality of a person such as impatient, gentle, or organized in the case of a basic control model imitating a person. That is, for example, if the cooperative activity includes a conversation, three basic control models of the moderate model, the steady model, and the traction model are stored in the basic model storage unit 21a. The moderate model, the steady model, and the traction model are different in at least one of, for example, conversation content, conversation speed, speaking frequency, or genre of a topic to be provided.

Furthermore, for example, in the case of a basic control model applied to an industrial machine, as an interaction with a person, a basic control model that has a speech and conduct (behavior) based on a typical work content that requires consideration for a person working together, such as one that performs cooperative design work such as an engineering tool, one that performs cooperative precision work such as a medical practice (surgery), or one that performs cooperative long-time work such as installation of large equipment, is stored in the basic model storage unit 21a.

In addition, the basic control model, that is, the typical pattern, may be classified by other typical characteristics of the subject of cooperative activity. As described above, the plurality of control models correspond to different personalities (personalities of activity). Note that the plurality of basic control models is not limited to this example, and the number of basic control models is also not limited to three.

The model selection reception unit 27 receives, from the user 5, a selection result indicating the basic control model selected by the user 5 from among the plurality of basic control models. For example, the model selection reception unit 27 may receive an input of a selection result from the user 5. In addition, the user 5 may input a selection result to another device such as a user terminal (not illustrated), that device may transmit the selection result to the control model generation unit 2c, and the model selection reception unit 27 may receive the selection result of the basic control model. The user 5 selects a basic control model from among a plurality of basic control models according to the preference or congeniality. For example, the user 5 may select a basic control model matching the cooperative activity target person 6 from among a plurality of basic control models. For example, in a case where three basic control models of the moderate model, the steady model, and the traction model are stored in the basic model storage unit 21a, and the cooperative activity target person 6 with which the user 5 is familiar has a moderate character, the moderate model may be selected. Note that, instead of being selected by the user 5, a basic control model suitable for the cooperative activity target person 6 may be selected by the control system 1c, an operator of the control system 1c, or the like.

The model selection reception unit 27 reads the basic control model corresponding to the received selection result from the basic model storage unit 21a, and outputs the read basic control model to the learning unit 22b. The learning unit 22b generates a control model using the basic control model received from the model selection reception unit 27, that is, the basic control model indicated by the selection result and the personal action data, similarly to the third embodiment, and outputs the generated control model to the robot control unit 3. Similarly to the third embodiment, the learning unit 22b updates the control model using the action result. Except for the above-described differences, the operation according to the present embodiment is the same as that in the third embodiment.

The control system 1c of the present embodiment is implemented by a computer system similarly to the control system 1b of the third embodiment. The control system 1c of the present embodiment may also be implemented by a plurality of computer systems, for example, may be implemented by a cloud system. In addition, as described above, the control model generation unit 2c and the robot control unit 3 may be configured as individual devices, and also in this case, the individual devices may be implemented by a plurality of computer systems.

As described above, the cooperative activity system 100c of the present embodiment generates the control model using the basic control model selected from the plurality of basic control models having different personalities of operations and the personal action data. Furthermore, the cooperative activity system 100c of the present embodiment updates the control model on the basis of an action result that is a result of the cooperative activity between the robot 7 and the user 5. Therefore, it is possible to achieve the same effects as those of the third embodiment and to cause the robot 7 to perform an activity more suitable for the preference and congeniality of the user 5.

In the above example, the function of generating the control model using the basic control model selected from the plurality of basic control models is added to the cooperative activity system 100b of the third embodiment, but the present disclosure is not limited thereto, and the function of generating the control model using the basic control model selected from the plurality of basic control models may be added to the cooperative activity system 100 of the first embodiment. For example, by adding the model selection reception unit 27 to the control model generation unit 2 of the cooperative activity system 100 and including the basic model storage unit 21a instead of the basic model storage unit 21, the control model may be generated using the basic control model selected from the plurality of basic control models as in the above-described example. In addition, the function of generating the control model using the basic control model selected from the plurality of basic control models may be added to the cooperative activity system 100a of the second embodiment. For example, by adding the model selection reception unit 27 to the control model generation unit 2a of the cooperative activity system 100 and including the basic model storage unit 21a instead of the basic model storage unit 21, the control model may be generated using the basic control model selected from the plurality of basic control models as in the above-described example.

### Fifth Embodiment

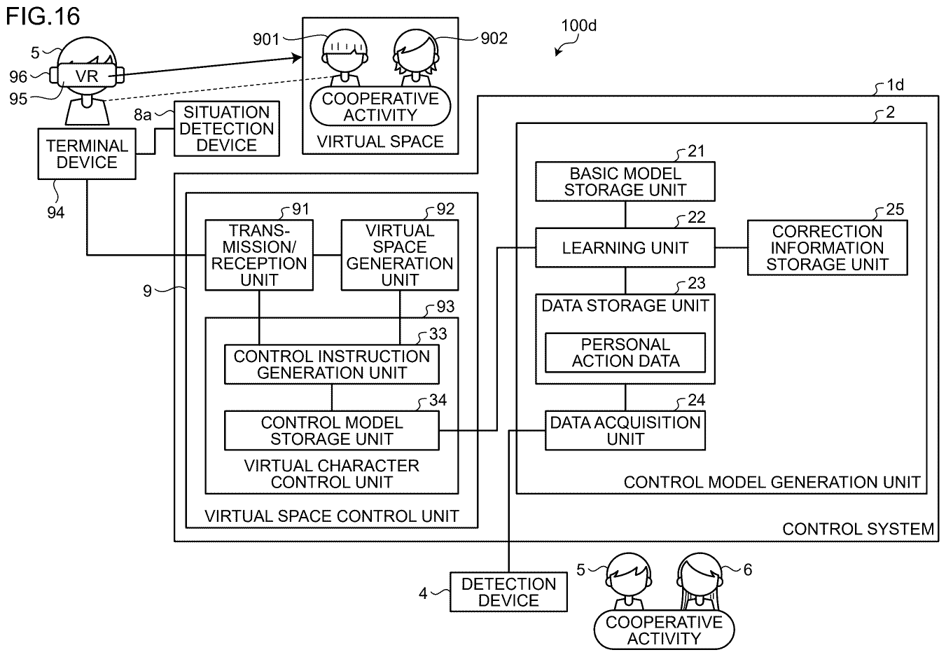

FIG. 16 is a diagram illustrating an exemplary configuration of a cooperative activity system according to the fifth embodiment. The cooperative activity system 100d of the present embodiment includes a control system 1d, the detection device 4, and a situation detection device 8a. The control system 1d generates a virtual space such as a metaverse and transmits virtual space information for allowing the user 5 to perceive the virtual space to a terminal device 94. The terminal device 94 outputs a video in the virtual space to a video presentation device 95 on the basis of the virtual space information received from the control system 1d, and outputs a voice in the virtual space to a voice presentation device 96. The user 5 performs a cooperative activity with a virtual character 902 via its own avatar 901 in the virtual space.

In the first to fourth embodiments, the robot 7 is exemplified as the humanoid that performs a cooperative activity with the user 5, but in the present embodiment, an example in which the humanoid that performs a cooperative activity with the user 5 is the virtual character 902 in the virtual space will be described. In the present embodiment, when the user 5 performs a cooperative activity with the virtual character 902, the virtual character 902 is controlled using a control model generated on the basis of personal action data of the user 5 acquired when performing a cooperative activity with the cooperative activity target person 6 in advance as in the first embodiment. Components having the same functions as those in the first embodiment are denoted by the same reference signs as those in the first embodiment, and redundant explanations are omitted. Hereinafter, differences from the first embodiment will be mainly described.

FIG. 16 illustrates an example in which the terminal device 94 transmits the video and the voice to the video presentation device 95 and the voice presentation device 96, respectively, by wireless communication, but the video and/or the voice may be transmitted by wired communication. Note that the terminal device 94 may be included in the control system 1d, or the terminal device 94, the video presentation device 95, and the voice presentation device 96 may be included in the control system 1d.

Furthermore, in FIG. 16, the video presentation device 95 and the voice presentation device 96 are used as means for the user 5 to perceive the virtual space, but means that allow for perception of one or more of haptic sensation, olfactory sensation, and taste sensation may be further used. The haptic sensation may include information to be perceived by the skin such as temperature in addition to stress. In addition, although the video presentation device 95 and the voice presentation device 96 are used in FIG. 16, either of them may not be used. Furthermore, FIG. 16 illustrates an example in which VR goggles and a head-mounted display are used as the video presentation device 95 and headphones are used as the voice presentation device 96, but the present disclosure is not limited thereto. For example, the video presentation device 95 may be a display or a monitor, the voice presentation device 96 may be a speaker, and specific examples of the video presentation device 95 and the voice presentation device 96 are not limited to the example illustrated in FIG. 16. Furthermore, two or more of the terminal device 94, the video presentation device 95, and the voice presentation device 96 may be integrated. For example, a display of the terminal device 94 may be used as the video presentation device 95. Furthermore, for example, a head-mounted display having both functions of the terminal device 94 and the video presentation device 95 may be used, or a head-mounted display with headphones may be used.

The situation detection device 8a acquires a situation of the user 5 in the cooperative activity between the user 5 and the virtual character 902. For example, the situation detection device 8a detects a voice, a motion, or the like of the user 5 and transmits the detection result to the terminal device 94. The terminal device 94 transmits the detection result received from the situation detection device 8a to the control system 1d. A plurality of situation detection devices 8a may be provided. Furthermore, for example, the voice presentation device 96 and the situation detection device 8a may be integrated by using a headset as the voice presentation device 96. Furthermore, the terminal device 94 may include the situation detection device 8a. Furthermore, the situation detection device 8a may be worn by the user 5, or may be provided around the user 5, such as an imaging device that captures the user 5 from the outside.

The control system 1d includes the control model generation unit 2 similar to that of the first embodiment and a virtual space control unit 9. The control model generation unit 2 and the virtual space control unit 9 may be provided as individual devices. The configuration and operation of the control model generation unit 2 are similar to those in the first embodiment, but the control model generated by the control model generation unit 2 is a control model for controlling the activity of the virtual character 902, and the basic control model stored in the basic model storage unit 21 is also a basic control model for controlling the activity of the virtual character 902.

The virtual space control unit 9 includes a transmission/reception unit 91, a virtual space generation unit 92, and a virtual character control unit 93. The transmission/reception unit 91 communicates with the terminal device 94 and exchanges information with the terminal device 94. The transmission/reception unit 91 acquires situation data indicating the situation of the user 5 in the cooperative activity from the terminal device 94, for example, and outputs the acquired situation data to the virtual space generation unit 92 and the control instruction generation unit 33. Note that the transmission/reception unit 91 may receive the situation data from the situation detection device 8a. Furthermore, the transmission/reception unit 91 transmits, for example, virtual space information to be described later received from the virtual space generation unit 92 to the terminal device 94.

The virtual space generation unit 92 generates a virtual space, generates virtual space information for allowing the user 5 to perceive the generated virtual space, and outputs the generated virtual space information to the transmission/reception unit 91. The virtual space information includes data indicating video (video data) and data indicating voice (voice data). Note that data indicating a voice may not be included in the virtual space information depending on the content of the cooperative activity and the virtual space. In addition, the virtual space information may include information that the user 5 can detect by haptic sensation and/or information that the user 5 can detect by olfactory sensation and taste sensation. Furthermore, the virtual space generation unit 92 generates virtual space information such that the avatar 901 of the user 5 in the virtual space performs an activity based on the situation data received from the transmission/reception unit 91. Furthermore, when receiving a control instruction to be described later from the virtual character control unit 93, the virtual space generation unit 92 generates virtual space information so that the virtual character 902 performs an activity based on the control instruction.

The virtual character control unit 93 is an example of an activity control unit (activity control device) that controls the humanoid. The virtual character control unit 93 includes the control instruction generation unit 33 and the control model storage unit 34. Similarly to the first embodiment, the control model storage unit 34 stores the control model generated by the control model generation unit 2. Note that this control model is a control model for controlling the activity of the virtual character 902 as described above. The control instruction generation unit 33 generates a control instruction for controlling the activity of the virtual character 902 using the situation data indicating the situation of the user 5 received from the transmission/reception unit 91 and the control model stored in the control model storage unit 34, and outputs the generated control instruction to the virtual space generation unit 92.

In the present embodiment, the control target is the virtual character 902 instead of the robot 7, but as in the first embodiment, before the cooperative activity between the virtual character 902 and the user 5 is performed, the control model is generated using the personal action data of the user 5 including the cooperative activity data acquired when the user 5 and the cooperative activity target person 6 perform the cooperative activity. Therefore, the virtual character 902 can perform an activity that is the same as or similar to the activity of the cooperative activity target person 6 from the start of the cooperative activity, and can reduce the stress of the user 5 due to the action and/or the way of speaking of the virtual character 902 in the cooperative activity.

Furthermore, in the example illustrated in FIG. 16, the virtual character control unit 93 is provided in the virtual space control unit 9, but the present disclosure is not limited thereto, and for example, the virtual space control unit 9 may be provided as an individual virtual space control device outside the control system 1d. In this case, the transmission/reception unit 91 and the virtual character control unit 93 are provided in the control system 1d, and the virtual space generation unit 92 is provided in the virtual space control device. The virtual space control device also includes the transmission/reception unit 91, the control instruction generated by the virtual character control unit 93 is transmitted to the virtual space control device via the transmission/reception unit 91 of the control system 1d, and the virtual space generation unit 92 of the virtual space control device receives the control instruction via the transmission/reception unit 91 of the virtual space control device. The virtual space generation unit 92 of the virtual space control device transmits the generated virtual space information to the terminal device 94 via the transmission/reception unit 91 of the virtual space control device. Furthermore, the transmission/reception unit 91 may be provided in the virtual character control unit 93. Also in this case, the virtual character control unit 93 and the control model generation unit 2 may be provided as separate devices.

The control system 1d of the present embodiment is implemented by a computer system similarly to the control system 1 of the first embodiment. The control system 1d of the present embodiment may also be implemented by a plurality of computer systems, for example, may be implemented by a cloud system. In addition, as described above, the control model generation unit 2 and the virtual space control unit 9 may be configured as individual devices, and also in this case, the individual devices may be implemented by a plurality of computer systems.

In the above-described example, the control model generation unit 2 of the first embodiment generates the control model for controlling the virtual character 902, and the virtual character control unit 93 controls the virtual character 902 using the generated control model. The present disclosure is not limited thereto, and when controlling the virtual character 902, the action result acquisition unit 26 may be provided and the control model may be updated using the action result as in the third embodiment, or the basic control model to be used may be selected from a plurality of basic control models for controlling the virtual character 902 using the model selection reception unit 27 as in the fourth embodiment.

In addition, both the update of the control model using the action result and the selection of the basic control model to be used from the plurality of basic control models may be performed.

### Sixth Embodiment

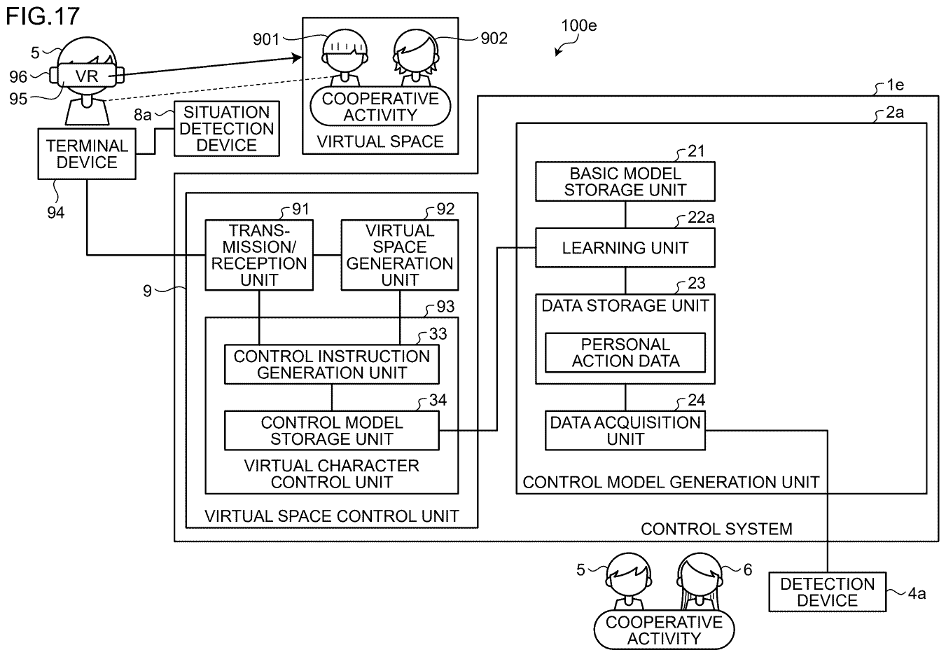

FIG. 17 is a diagram illustrating an exemplary configuration of a cooperative activity system according to the sixth embodiment. The cooperative activity system 100e of the present embodiment includes a control system 1e, the detection device 4a, and the situation detection device 8a. The control system 1e generates a virtual space such as a metaverse and transmits virtual space information for allowing the user 5 to perceive the virtual space to the terminal device 94, as in the fifth embodiment. The situation detection device 8a, the terminal device 94, the video presentation device 95, and the voice presentation device 96 are similar to those in the fifth embodiment. Note that the terminal device 94 may be included in the control system 1e, or the terminal device 94, the video presentation device 95, and the voice presentation device 96 may be included in the control system 1e.

The control system 1e includes the control model generation unit 2a similar to that of the second embodiment and the virtual space control unit 9 similar to that of the fifth embodiment. The control model generation unit 2a and the virtual space control unit 9 may be provided as individual devices. The configuration and operation of the control model generation unit 2a are similar to those in the second embodiment, but the control model generated by the control model generation unit 2a is a control model for controlling the activity of the virtual character 902, and the basic control model stored in the basic model storage unit 21 is also a basic control model for controlling the activity of the virtual character 902. Components having the same functions as those in the second or fifth embodiment are denoted by the same reference signs as those in the second or fifth embodiment, and redundant explanations are omitted. Hereinafter, differences from the second or fifth embodiment will be mainly described.

In the present embodiment, as in the second embodiment, the control model generation unit 2a generates the control model on the basis of the personal action data of the cooperative activity target person 6 acquired by the detection device 4a when performing the cooperative activity with the user 5. This control model is a control model for controlling the activity of the virtual character 902 as described above. The virtual character control unit 93 of the virtual space control unit 9 controls the virtual character 902 using the control model generated by the control model generation unit 2a as in the fifth embodiment.

Furthermore, as described in the fifth embodiment, for example, the virtual space control unit 9 may be provided as an individual virtual space control device outside the control system 1e.

In the present embodiment, the control target is the virtual character 902 instead of the robot 7, but as in the first embodiment, before the cooperative activity between the virtual character 902 and the user 5 is performed, the control model is generated using the personal action data of the cooperative activity target person 6 including the cooperative activity data acquired when the user 5 and the cooperative activity target person 6 perform the cooperative activity. Therefore, the virtual character 902 can perform an activity that is the same as or similar to the activity of the cooperative activity target person 6 from the start of the cooperative activity, and can reduce the stress of the user 5 due to the action and/or the way of speaking of the virtual character 902 in the cooperative activity.

The control system 1e of the present embodiment is implemented by a computer system similarly to the control system 1a of the second embodiment. The control system 1e of the present embodiment may also be implemented by a plurality of computer systems, for example, may be implemented by a cloud system. In addition, as described above, the control model generation unit 2a and the virtual space control unit 9 may be configured as individual devices, and also in this case, the individual devices may be implemented by a plurality of computer systems.

Note that, in the above example, an example has been described in which the virtual character 902 performs a cooperative activity, and the personal action data includes cooperative activity data. However, the control model of the virtual character 902 only needs to be generated using personal action data indicating the personality of a specific person, and the applied activity is not limited to the cooperative activity. That is, personal action data that is data related to the activity of a specific person is stored in the data storage unit 23, and the learning unit 22a only needs to generate, using the personal action data, a control model that is a control model of the virtual character 902 in the virtual space and that reflects the personality of the specific person. For example, the user 5 sets a specific person, and a control model of the virtual character 902 is generated using the personal action data of the specific person, so that a control model reflecting the personality of the specific person according to the request of the user 5 is generated. As a result, it is possible to reduce the stress of the user 5 when the user 5 has a conversation with the virtual character 902 or views the speech and conduct of the virtual character 902. In addition, the method of setting a specific person is not limited to this example. Since the control model of the virtual character 902 is generated on the basis of the personal action data of the specific person, it is possible to generate a control model reflecting the action and/or the way of speaking of the specific person, and to reflect a personality that is the action and/or the way of speaking of the specific person on the virtual character 902.

In the above-described example, the control model generation unit 2a of the second embodiment generates the control model for controlling the virtual character 902, and the virtual character control unit 93 controls the virtual character 902 using the generated control model. The present disclosure is not limited thereto, and when controlling the virtual character 902, the action result acquisition unit 26 may be provided and the control model may be updated using the action result as in the third embodiment, or the basic control model to be used may be selected from a plurality of basic control models for controlling the virtual character 902 using the model selection reception unit 27 as in the fourth embodiment. In addition, both the update of the control model using the action result and the selection of the basic control model to be used from the plurality of basic control models may be performed.

The configurations described in the above-mentioned embodiments indicate examples. The embodiments can be combined with another well-known technique and with each other, and some of the configurations can be omitted or changed in a range not departing from the gist.

### REFERENCE SIGNS LIST

1, 1a, 1b, 1c, 1d, 1e control system; 2, 2a, 2b, 2c control model generation unit; 3 robot control unit; 4, 4a detection device; 5 user; 6 cooperative activity target person; 7 robot; 8, 8a situation detection device; 9 virtual space control unit; 21, 21a basic model storage unit; 22, 22a, 22b data storage unit; 24 data acquisition unit; 25 correction information storage unit; 26 action result acquisition unit; 27 model selection reception unit; 31 instruction transmission unit; 32 situation acquisition unit; 33 control instruction generation unit; 34 control model storage unit; 91 transmission/reception unit; 92 virtual space generation unit; 93 virtual character control unit; 94 terminal device; 95 video presentation device; 96 voice presentation device; 100, 100a, 100b, 100c, 100d, 100e cooperative activity system.

1. A control model generation device comprising:
processing circuitry including a memory
to store personal action data that is data related to an activity of a person who has performed a cooperative activity, and
to generate, by using the personal action data stored in the memory, a control model of a humanoid for the humanoid to perform the cooperative activity with a user, the control model reflecting a personality of the person, wherein
the personal action data includes data acquired when the user performs the cooperative activity with a cooperative activity target person with which the user is familiar.

2. The control model generation device according to claim 1, wherein the person is the user.

3. The control model generation device according to claim 1, wherein the person is the cooperative activity target person.

4. The control model generation device according to claim 1, wherein the humanoid is a robot.

5. The control model generation device according to claim 1, wherein the humanoid is a virtual character in a virtual space.

6. The control model generation device according to claim 1, wherein the processing circuitry is configured to update the control model based on an action result that is a result of the cooperative activity performed by the humanoid and the user, and on the control model corresponding to the action result.

7. The control model generation device according to claim 1, wherein the processing circuitry is configured to generate the control model using a basic control model predetermined and the personal action data.

8. The control model generation device according to claim 7, comprising
a selection result receiver to receive a selection result indicating the basic control model selected by the user from among a plurality of the basic control models, wherein
the processing circuitry is configured to generate the control model using the basic control model indicated by the selection result and the personal action data.

9. The control model generation device according to claim 1, wherein
the processing circuitry is configured to extract a feature indicating a personality of the person from the personal action data, and
the personality includes at least one of habitual saying, intonation, dialect, or habit of movement.

10. The control model generation device according to claim 1, wherein the personal action data includes data acquired by a wearable terminal and/or data in which activity of the person in a virtual space is recorded.

11. A control model generation device comprising:
processing circuitry including a memory
to store personal action data that is data related to an activity of a person, and
to generate, using the personal action data stored in the memory, a control model of a virtual character in a virtual space, the control model reflecting a personality of the person.

12. A robot control device comprising:
processing circuitry including a memory
to generate a control instruction for a humanoid, wherein
the memory stores a control model of the humanoid for the humanoid to perform a cooperative activity with a user, the control model being generated using personal action data that is data related to an activity of a person who has performed a cooperative activity, the control model reflecting a personality of the person,
the processing circuitry is configured to generate a control instruction for the humanoid using the control model, and
the personal action data includes data acquired when the user performs the cooperative activity with a cooperative activity target person with which the user is familiar.

13. A control system comprising:
the control model generation device according to claim 1; and
a robot control device to control a humanoid, wherein
the robot control device controls the humanoid using the control model.

14.-15. (canceled)

16. The control model generation device according to claim 5, wherein the processing circuitry is configured to update the control model based on an action result that is a result of the cooperative activity performed by the humanoid and the user, and on the control model corresponding to the action result.

17. The control model generation device according to claim 5, wherein the processing circuitry is configured to generate the control model using a basic control model predetermined and the personal action data.

18. The control model generation device according to claim 5, wherein
the processing circuitry is configured to extract a feature indicating a personality of the person from the personal action data, and
the personality includes at least one of habitual saying, intonation, dialect, or habit of movement.

19. The control model generation device according to claim 5, wherein the personal action data includes data acquired by a wearable terminal and/or data in which activity of the person in a virtual space is recorded.
